(19) United States
(12) Patent Application Publication
(10) Pub. No.: US 2011/0201300 A1
(43) Pub. Date: Aug. 18, 2011

(54) EMERGENCY CONTACT INFORMATION DEVICE AND METHOD

(76) Inventor: SAMUEL ORNSTEIN, Woodstock, GA (US)

(21) Appl. No.: 12/722,330

(22) Filed: Mar. 11, 2010

Related U.S. Application Data
(60) Provisional application No. 61/305,798, filed on Feb. 18, 2010.

(51) Int. Cl. H04M 11/04; H04M 3/42

(52) U.S. Cl. 455/404.1; 455/414.1

(57) ABSTRACT

A mobile computing device for storing and retrieving contact information, such as emergency contact information, is disclosed, including a processor, a data store, and a contact organizer software module. The contact organizer is configured to detect one of several indications of a number of corresponding emergency conditions, retrieve contact data from the data store based on the detected indication, and present the retrieved contact data by displaying the data and/or by voice communication.

### CROSS REFERENCE TO RELATED APPLICATIONS

The present non-provisional application claims priority to provisional application 61/305,798, filed on 18 Feb. 2010, titled “EMERGENCY CONTACT INFORMATION DEVICE AND METHOD.” The specification of said provisional application is hereby incorporated by reference in its entirety.

### BACKGROUND

This application relates generally to the storage and retrieval of contact information. More specifically, this application relates to a mobile device and methods for entering and retrieving contact information and requesting emergency help.

### SUMMARY

A mobile computing device for storing and retrieving contact information is disclosed, including a processor, a data store, and a contact organizer software module. The contact organizer is configured to detect one of several indications of a number of corresponding emergency conditions, retrieve contact data from the data store based on the detected indication, and present the retrieved contact data.

A computer-readable medium is disclosed carrying instructions that detect one of a number of indications of a number of corresponding emergency conditions, retrieve contact data from a data store based on the detected indication, and present the retrieved contact data.

### BRIEF DESCRIPTION OF THE DRAWINGS

The drawings, when considered in connection with the following description, are presented for the purpose of facilitating an understanding of the subject matter sought to be protected.

FIG. 1 is an example computing environment in which the present disclosure may be practiced;

FIG. 2 is an example computing device with a non-exhaustive set of components;

FIG. 3 is an example schematic diagram of a data structure for storing contact information; and

FIG. 4 is an example flow diagram of an emergency help request process using the computing device of FIG. 2.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references emergency contact information, it will be appreciated that the disclosure may be used to other types of contact information and is not limited solely to emergency information.

Briefly described, in one embodiment, a mobile computing device application is disclosed, including a data store for storing emergency contact information such as a user's name, family contact information, doctor's contact information, hospital address, and the like, that may be used to request help when the user is incapacitated and/or is in a situation that cannot obtain help by himself. Other non-emergency contact information, such as data about hotel, taxi, plumber, locksmith, and the like may also be stored in the data store for easy retrieval when needed. In another embodiment, a Global Positioning System (GPS) may be installed on the mobile computing device to provide localized data that may be used to obtain and/or retrieve local contact information, such as a hospital phone number and address, in a city other than the user's home town.

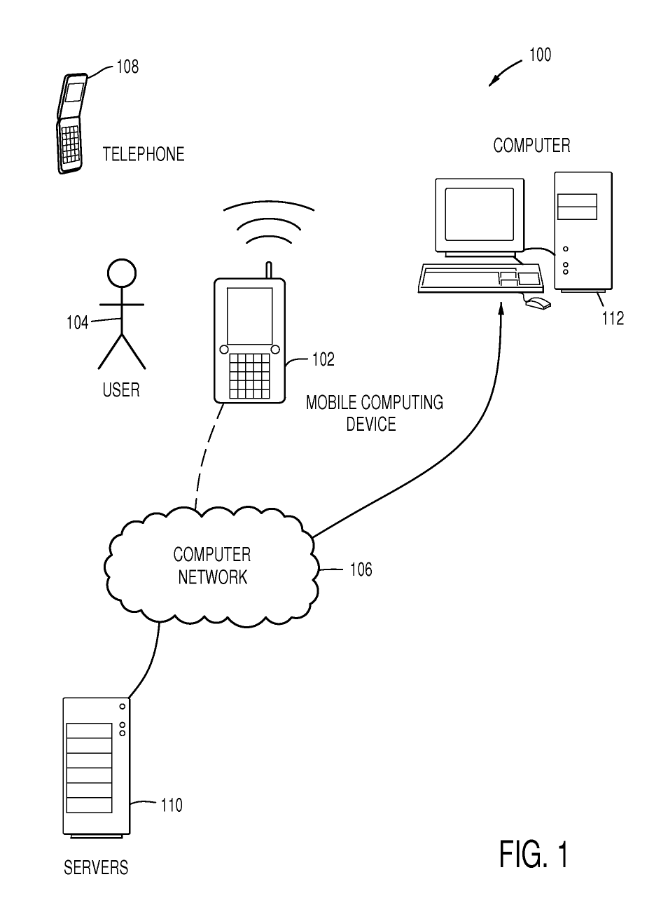

FIG. 1 is an example computing environment in which the present disclosure may be practiced. In one embodiment, a user 104 may use computing environment 100, which may include mobile computing device 102, telephone 108, server 110, computer 112, and computer network 106. In one embodiment, user 104 may use mobile computing device 102 to communicate with telephone 108 using wireless cell communication networks. Mobile computing device 102 may also communicate with one or more computer 112 and server 110 via computer network 106. Mobile computing device 102 may also communicate with a person other than user 104 via a speaker and/or a display built into mobile computing device 102.

Mobile computing device 102 includes cell phones, satellite phones, smart phones, Personal Digital Assistants (PDA), laptop or notebook/netbook computers, and any other portable computing device capable of interfacing with a human operator, and/or communicating with other devices over a computer communication network. Mobile computing device 102 typically includes some storage space, wireless communications circuitry, user interface including a display and a hard or soft keyboard/keypad, a speaker, and other similar components suitable and/or necessary for mobile computing and communications.

Computer network 106 typically includes routers, gateways, servers, network cables and/or optical fibers, cell towers, and other such communication equipment needed to connect two computing devices together. Computer network 106 may include the Internet, Local Area Networks (LAN), Wireless Local Area Network (WLAN), Wide Area Networks (WAN), Virtual Private Networks (VPN), and any other type of network capable of providing a communication path between two or more computing devices. Well-known Internet, wireless, and other communication protocols may be used for such communications. These protocols include Hyper Text Transfer Protocol (HTTP) used on the World Wide Web (WWW), Transport Connection Protocol/Internet Protocol (TCP/IP), Wired Equivalent Protocol (WEP), WiFi (example, 802.11g), Wireless Application Protocol (WAP), and many others.

Telephone 108 may include any type of phone or voice communication equipment such as landline based phones, cell phones, office phone systems, smart phones, and the like.

Computer 112 includes any personal or mainframe computer equipped with a Network Interface Card (NIC) that may send and receive network packets in a wired or wireless networking environment. Examples of such computers are PC, MAC, and UNIX workstations that come in a variety of sizes, such as desktop, laptop, and notebook.

Servers 110 include a variety of computers that provide services to other computers (called clients) over computing network 106. For example, web servers are servers that provide web pages to be browsed on client computers using browser programs. Other types of servers include FTP (File Transfer Protocol) servers, file servers, application servers, database servers, and the like.

In operation, user 104 may need contact information for various people, services, and/or locations. User 104 may use mobile computing device 102 to retrieve such contact information. In one embodiment, mobile computing device 102 provides a user interface for searching and/or browsing for contact information stored therein. Many familiar user interfaces may be used for searching for information, including a local search function on mobile computing device 102, and a tree-like hierarchical file system where various data may be placed and subsequently found. However, these traditional interfaces may be cumbersome to use and difficult to update. In another embodiment, a contact organizer software application module may be used for organizing and retrieving such contact information.

A software application, such as the contact organizer, may be built into mobile computing device 102 or be subsequently downloaded from a service center. The contact organizer module may be used to enter, classify, and retrieve data easily and keep all contact information, including emergency contact information, in one, easy to find, and easy to update place. In one embodiment, the contact organizer application may also provide a voice command interface and a speech and/or playback function. The voice command function may assist user 104 in finding information by giving voice commands to mobile computing device 102, such as “find phone number of Dr. Roberts”, “find address of gas station”, or “dial home”.

In one embodiment, the speech function of the contact organizer may be used to play back pre-recorded messages or sounds, such as music, prayers, natural sounds, or requests for help in emergency situations where the user may not be able to speak. User 104 may record any desired message that may be later played back. For example, user 104 may record, in his own voice or another's voice, messages such as: “Help me,” “Call the Police,” “Call the Fire Department,” “Call Dr. Jones,” “Call Reverend Smith,” “Call Operator,” “Call 911,” and the like. Pre-recorded messages or sounds may be used for purposes other than emergency. For example, pre-recorded scripts for self-hypnosis, anxiety calm-down, prayers of a particular denomination, and the like may be recorded and played back as desired. Such messages may also be presented to a passerby or other person in close proximity to summon help.

In another embodiment, the contact organizer may be coupled with a GPS unit to provide localized data to user 104. GPS provides the locality to the contact organizer, which in turn, searches a local data store for information pertinent to the given locality. For example, if user 104's home town is New York, but user 104 is currently in Chicago, the GPS unit provides this locality information to the contact organizer. If the user asks for the address of a hospital, the contact organizer searches its local data store to find the address and phone number of local hospitals in Chicago. In another embodiment, if contact information is not found locally on mobile computing device 102, the contact organizer may use servers and/or services available on the Internet to acquire and save information about local businesses and services for subsequent use. In the above example, if the address of a local hospital is not known, the contact organizer may query a service, for example, a directory service, on the Internet to obtain the needed contact information.

In another embodiment, the contact organizer may offer alarm or user notification for appointments that may be set by user 104. The alarm may be implemented in the form of a sound, such as a beep or tone, an email sent to the user at a predetermined email address, a short text message, a spoken voice message, a flashing light, or a combination thereof. The data stored on mobile computing device 102 may be encrypted using a variety of encryption methods for added privacy and security.

Those skilled in the art will appreciate that the contact organizer software application may be implemented as a single module or multiple modules, where each module may handle a different function. For example, there may be a voice command module, a database interface module, a speech and/or playback module, a network query module, a GPS interface module, and the like.

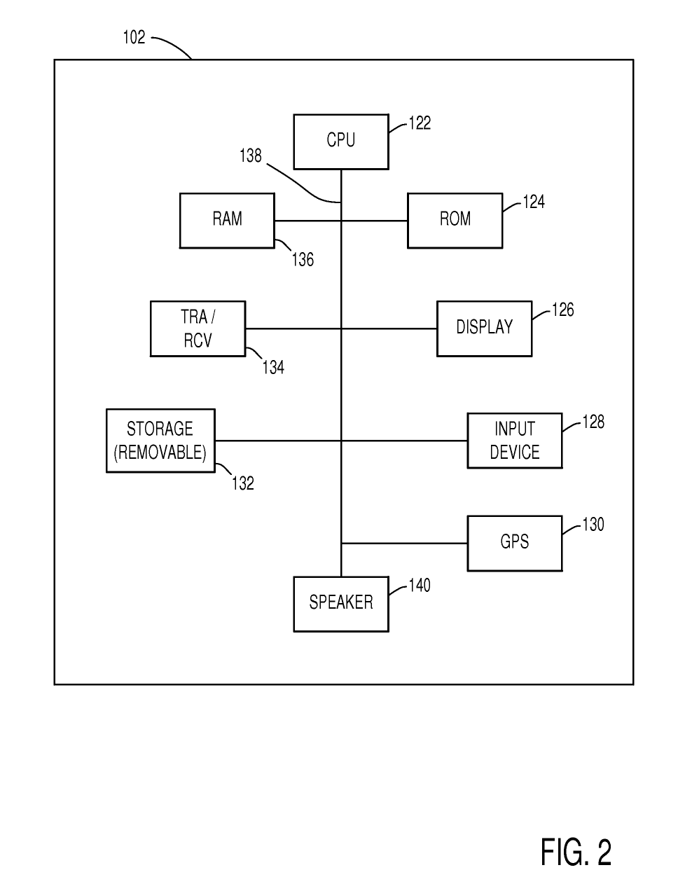

FIG. 2 is an example computing device with a non-exhaustive set of components. Mobile computing device 102 may include at least Central Processing Unit (CPU) 102, Read Only Memory (ROM) 124, display unit and interface 126, input device and interface 128, GPS 130, storage unit 132, transmitter/Receiver (transceiver) unit 134, and Random Access Memory (RAM) 136.

In one embodiment, CPU 102 is the main processing unit. In another embodiment, multiple processors of the same type or different types may be used. For example, a math coprocessor, a graphic coprocessor, and the like, may be included in the processing portion of mobile computing device 102.

ROM 124 is generally used to store non-volatile data, such as the operating system, telephony and communication service parameters, manufacturer's identification, and the like.

In various embodiments, display unit and interface 126 may include a screen that may be touch-sensitive, LEDs (Light Emitting Diode), and the electrical interface between CPU and the display.

In various embodiments, input device and interface 128, may include a touch-sensitive screen, a keyboard, various hardware and software buttons and keys, and the like, used for inputting data.

In various embodiments, GPS 130 may include hardware GPS components, such as satellite communication modules, and the interface to CPU 122.

In various embodiments, storage unit 132 may include flash (non-volatile) memory, a miniature hard drive, a removable flash disk of various form factors, and the like.

In various embodiments, transceiver 134 is used to send and receive communication packets from computer network 106.

In various embodiment, RAM 136 includes volatile memory that may be used during run time to store executable application programs and related data.

In various embodiments speaker 140 may be used to play sounds and speech, both pre-recorded and synthesized.

Various software application programs, such as the content organizer, may be stored in various storage areas including ROM 124, RAM 136, and/or storage unit 132. Generally, software programs are loaded into RAM for execution. Similarly, data, including contact information may be loaded in any of these storage areas. In one embodiment, data may be stored in text files, while in another embodiment, a database may be implemented in a storage area to contain data. A database, such as a relational database, may be queried (for example, using a query language) efficiently to find various related information, such as names, phone numbers, addresses, and the like.

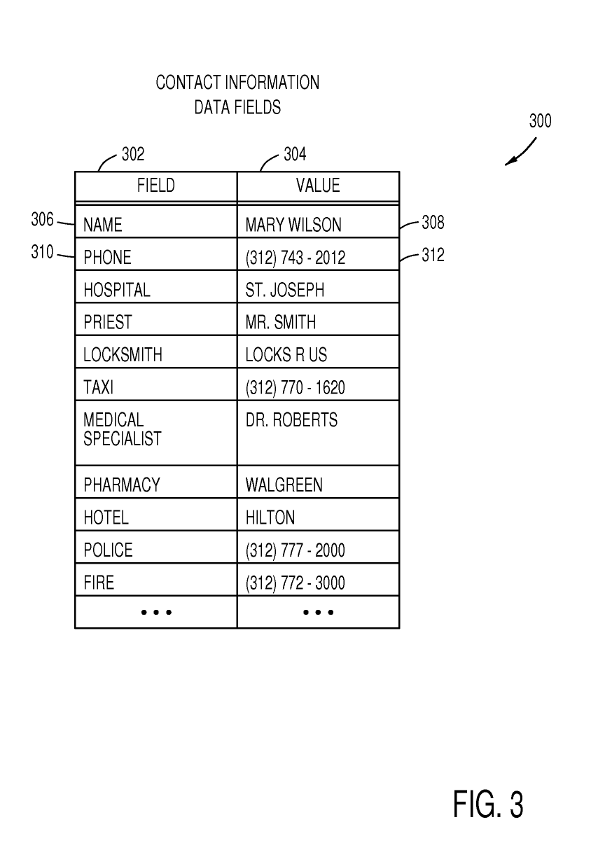

FIG. 3 is an example schematic diagram of a data structure for storing contact information. Data structure 300 may include data fields 302, each associated with a corresponding data value 304. Those skilled in the art will appreciate that many data structure designs may be used to store data, depending on application and complexity of the data. In the simplest form, a name-value pair may be used. For example, a Name field 306 may be associated with a corresponding value field 308. Similarly, a Phone field 310 may be associated with a corresponding value field 312. In one embodiment, more complex data structures may be used in a database including various relationships indicated in various additional parameters for each data record (metadata) such as locality, priority, language, conditions for contact (e.g., emergency condition, missed appointment, and the like), update date and time, security level, validity flag, and the like.

Data field that may be stored in mobile computing device 102 may include information about name, address, telephone number, birth date, height, weight, social security, Medicare, Medicaid, religion, blood type, current medications, allergies, medical data, doctors, next of kin, relatives, friends, user name and password code, etc. Additional current and/or local information may include information about hospital, specialist, clinic, dentist, police, fire, burn center, ambulance service, taxi service, locksmith, electric company, gas company, gas station, car rental service, post office, plumber, handyman, pharmacy, pharmacist, auto repair, towing company, bookstore, movie theatre, priest, rabbi, pastor, reverend, optometrist, eye glass store, hotel, parking lot, home depot, Lowe's, television repair, computer repair, computer supplies, and retail stores such as Office Max, Office Depot, Staples, Starbucks, Dunkin Donuts, McDonald's, Wendy's, Burger Kings, Chic Fil A, Publix, Kroger's and Walmart, and the like.

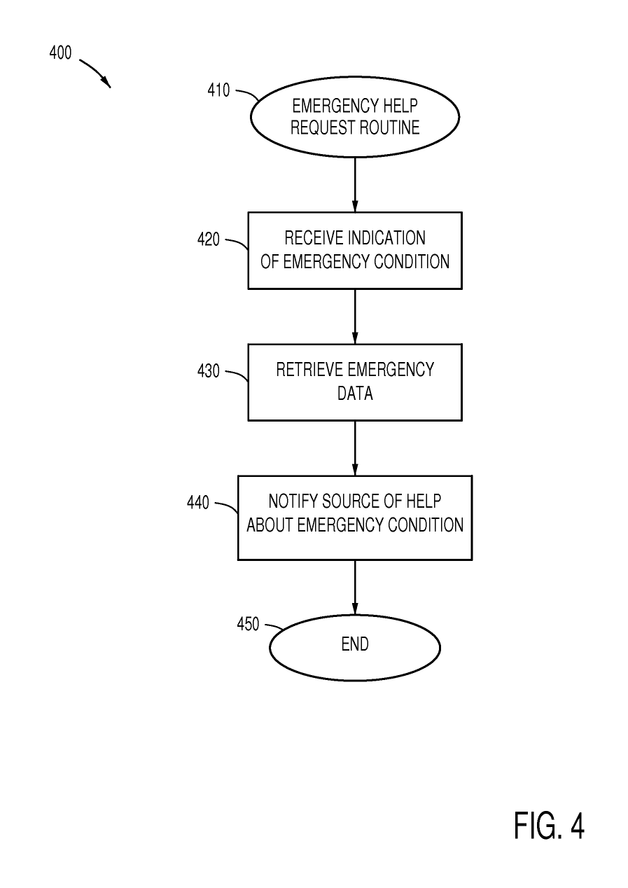

FIG. 4 is an example flow diagram of an emergency help request process using the computing device of FIG. 2. In emergency situations, user 104 may be incapacitated or be in a condition that prevents him from communicating effectively. In such situations, user 104 may invoke the emergency assistance function of the contact organizer, as described below.

Routine 400 starts at block 410 and proceeds to block 420 where it is determined whether an indication of an emergency condition exists. In one embodiment, the indication may include activation of a hardware button, a software button, a menu item in a user interface of mobile computing device 102, a voice command, and the like. In one embodiment, the indication of emergency condition may be generic, while in other embodiments, several specific types of indications may be selectable. In the latter embodiment, each one of the several indications may specify a different type of emergency condition and corresponding contact information to be retrieved. For example, in a security emergency, police and/or fire contact information may be retrieved, while in a medical emergency, a doctor's or a hospital's contact information may be provided.

Different indications may be pre-defined by assigning or associating with each indication a different key, button, menu item, or similar activation mechanism. Indications may further be associated with certain data in the data store to be retrieved and presented when the corresponding indication is invoked.

Routine 400 proceeds to block 430 and retrieves data corresponding to the locality provided by GPS, and/or based on the type of indication. The data may be retrieved from a local database stored in mobile computing device 102, or from an external source if the data does not exist in the local database or is out-dated or invalid.

At block 440, routine 400 reveals or presents the retrieved data by displaying and/or speaking the retrieved data.

Routine 440 terminates at block 450.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A mobile computing device for storing and retrieving contact information, the mobile computing device comprising:
a processor;
a data store; and
a contact organizer module executed by the processor and configured to detect one of a plurality of indications of a plurality of corresponding emergency conditions, retrieve contact data from the data store based on the one of a plurality of indications, and present the retrieved contact data.

2. The mobile computing device of claim 1, further comprising a speaker used to present the retrieved contact data by voice communication.

3. The mobile computing device of claim 1, further comprising a screen used to display the retrieved contact data.

4. The mobile computing device of claim 1, further comprising a GPS unit.

5. The mobile computing device of claim 1, wherein the mobile computing device is a mobile phone.

6. The mobile computing device of claim 1, wherein the contact organizer module is further configured to receive and store new data.

7. The mobile computing device of claim 1, wherein the contact organizer module is further configured to receive and respond to voice commands.

8. The mobile computing device of claim 1, wherein the contact organizer module is further configured to play back pre-recorded messages.

9. A computer-readable medium having instructions encoded thereon that when executed by a processor cause the processor to:
detect one of a plurality of indications of a plurality of corresponding emergency conditions;
retrieve contact data from a data store based on the one of a plurality of indications; and
present the retrieved contact data.

10. The computer-readable medium of claim 9 having instructions encoded thereon that when executed by a processor further cause the processor to store new data in the data store.

11. The computer-readable medium of claim 9 having instructions encoded thereon that when executed by a processor further cause the processor to respond to voice commands.

12. The computer-readable medium of claim 9 having instructions encoded thereon that when executed by a processor further cause the processor to play back pre-recorded messages.

14. The computer-readable medium of claim 12, wherein the pre-recorded messages include content substantially equivalent to one of “Help me,” “Call the Police,” and “Call the Fire Department.”

15. The computer-readable medium of claim 9 having instructions encoded thereon that when executed by a processor further cause the processor to receive data based on information provided by a GPS unit.

16. A method of obtaining emergency help, the method comprising:
determining whether an indication of an emergency condition exists;
determining a type of the emergency condition;
retrieving data associated with the determined type of the emergency condition from a data store; and
presenting the retrieved data.

17. The method of claim 16, wherein the retrieved data is at least partially based on information provided by a GPS unit.

18. The method of claim 16, wherein the retrieved data includes a pre-recorded message.

19. The method of claim 18, wherein the pre-recorded message is presented by playback.

20. The method of claim 16, further comprising storing new data in the data store.
